(19) United States
(12) Patent Application Publication
(10) Pub. No.: US 2008/0222428 A1
(43) Pub. Date: Sep. 11, 2008

(54) Method for Securing Authenticity of Data in a Digital Processing System

(76) Inventor: Andrew Dellow, Minchinhampton (GB)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 12/043,697

(22) Filed: Mar. 6, 2008

Related U.S. Application Data
(60) Provisional application No. 60/905,307, filed on Mar. 7, 2007.

(51) Int. Cl. H04L 9/06; G06F 17/30

(52) U.S. Cl. 713/193; 707/201

(57) ABSTRACT

The invention describes a method and a corresponding digital processing system for ensuring that data is unmodified while reducing the amount of one-time programmable memory in the system. The data is stored in modifiable memory and an authentication value of the data is stored in unmodifiable memory. Before the data is used according to its purpose the digital processing system authenticates that the data is unmodified, for example by using a cryptographic hash algorithm.

### CROSS-REFERENCE TO RELATED APPLICATIONS

This application claims benefit to U.S. Provisional Application No. 60/905,307, filed on Mar. 7, 2007, entitled, “Method to Reduce On-Chip One Time Programmable Memory Using hash Lock”, which is incorporated by reference in its entirety herein.

### FIELD OF THE INVENTION

The invention relates to a method and a corresponding electrical circuit for authenticating data in a digital processing system and in particular a system on a chip (SOC).

### BACKGROUND OF THE INVENTION

The term “system on a chip” (SOC) refers to the integration of all or nearly all necessary electronic circuits of diverse functions onto a single chip, to come up with a complete electronic system. This electronic system can be adapted to perform the functions of a final product. Thus, instead of building an electronic product by assembling various chips and components on a circuit board, SOC technology allows all or—depending on the specific needed functions—most of these parts to be fabricated together on a single chip, which can function as the final product itself.

SOCs can be designed to operate in different markets and environments, wherein the mode of operation can be set in a number of ways. That is the SOC is capable of performing different functions, but the actual performed functions are selected by some configuration means. A general purpose SOC can be configured for special functions. The configuration of a SOC for example can be set for example by bond options, which are small wire links within the chip package, or software or some form of non-volatile memory. By using one of these configuration means for example a security configuration item can be activated, for example to perform a particular decryption algorithm, or a hardware configuration item can be enabled or disabled, for example such as a USB port. These options may set by the manufacturer according to the options chosen by the final customer at manufacturing time when the specific part number is produced.

For storing data that must not be modified by a customer or any other unauthorized person, unmodifiable memory, for example one-time programmable memory, may be used. Data, which must not be modified, may be configuration data relating to security aspects of the circuit, for example configuration information.

With increasing functionality of SOCs the amount of configuration data has grown rapidly. Accordingly the amount of OTP memory and the corresponding area within the SOC has increased and has become significant in the latest generations of SOCs. However in may cases one cannot simply swap the contents to be stored to some memory external to the SOC, because said contents must not be changed or replaced.

Besides the area needed for one time programmable memory on a chip the associated cost has to be taken into account. Thus there is a demand for a method for ensuring that data used in a digital processing system are the original data, i.e. the data processed are unmodified, while the method at the same time reduces the amount of unmodifiable memory.

### SUMMARY OF THE INVENTION

The present invention comprises a method and a corresponding circuit for securing authenticity of data in a digital processing system, and a digital processing system substantially as shown in and/or described in connection with at least one of the figures, as set forth more completely in the claims.

### BRIEF DESCRIPTION OF THE DRAWING

FIG. 1 depicts a schematic of a digital processing system for employing the invention

### DETAILED DESCRIPTION OF THE INVENTION

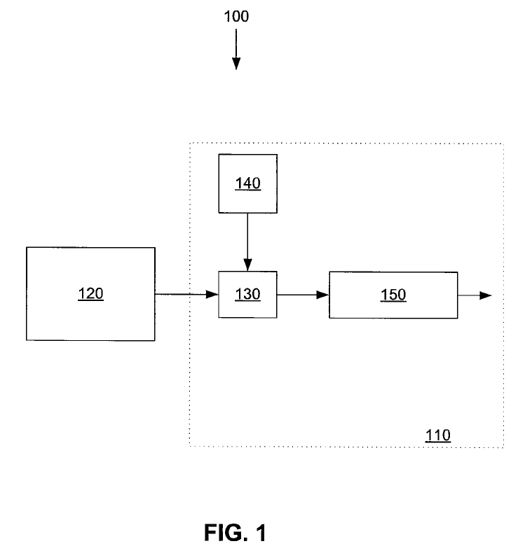

FIG. 1 depicts a digital processing system 100, which may be for example comprised in a set top box for processing a stream of data representing a pay TV channel. System 100 comprises an electrical circuit 110, which in particular may be a system on a chip (SOC), and memory 120, which couples to the SOC 110 at least for read access.

Memory 120 may be any conventional random access memory (RAM), which may store any kind of data and which is not protected from being accessed from outside the DPS 100. In particular memory 120 may also be non-volatile memory, for example such as flash memory, which will maintain the data persistently even when powered off. The data stored in memory 120 for example may be configuration data to be loaded by the SOC for configuring or the data may be any executable program to be loaded and executed by SOC 110.

SOC 110 comprises elements known from conventional systems, for example a central processing unit capable of executing a loaded program, interfaces to peripheral elements for sending and receiving data, a bus system for transferring data within the SOC and some memory, which is internal in the SOC and accordingly incorporated in the housing of the SOC. As these elements and their function are known from conventional SOCs they are not detailed here. Besides other known elements the SOC 110 comprises a security module 130, unmodifiable memory 140 and modifiable memory 150.

The security module 130 may be a general-purpose processing unit capable of executing a security program as detailed herein later or may be any special processing unit optimized for executing the program or cryptographic calculations. In any case module 130 should be protected from any access from outside the SOC in order to prevent any manipulation. As indicated in the drawing security module 130 is connected to memory 120 outside the SOC, wherein the connection is at least for reading, such that module 130 may read data from memory 120.

Also unmodifiable memory 140 is coupled to security module 130. In one example unmodifiable memory may be one-time programmable memory, which due to its intrinsic properties cannot be modified at all once written even if unlimited access is granted. Such one-time programmable memory can be realized for example by using fuses as memory cells, wherein a fuse may be fused or conducting thus identifying a bit. Once a fuse has been fused there is no chance to recombinate the fuse for amending the state of the memory cell. Accordingly memory 140 can be written only once.

Module 130 is furthermore coupled to memory 150, to which the module has write access to store data in. As it is intended to use memory 150 as a cache internal to the SOC, the memory may be volatile. Other components comprised in the SOC may be also coupled to memory 150 at least for read access, such that they may further process any data written to memory 150 by module 130.

In order to reduce the amount of unmodifiable memory in the SOC the data to be processed and which must not be modified is stored in memory 120 thus outside the SOC. When the data is needed for some kind of processing in the SOC it is read from memory and authenticated in the SOC to ensure that the data is unmodified.

In one example the data may be configuration information needed by the SOC for any configuration settings. Said configuration information is usually known at manufacturing time when the utilization of the SOC is defined. The data, i.e. the configuration information may thus control the mode of operation of the SOC or may allow or disallow functions of the digital processing system. This configuration information is then stored in memory 120, such that it could be accessed not only by SOC 110 but also by any hacker trying to manipulate the configuration of the SOC. In order to prevent any successful manipulation, i.e. any modification of the configuration data, a hash value of the original configuration data is calculated at manufacturing time and the calculated hash value is stored in unmodifiable memory 140 in the SOC.

For calculating the hash value of the data a conventional hash function or hash algorithm, in particular a cryptographic hash function, is used, wherein a cryptographic hash function shall be understood as a one-way function for computing a digital fingerprint, also known as message digest, of an input data sequence, wherein preferably but not necessarily the input data sequence may be of any length. Known hash algorithms for example comprise SHA-1, which produces a hash value of 160 bit length, or SHA-224 producing values of 224 bit length or SHA-256, SHA-384 and SHA-512 producing values of 256, 384 or 512 bit length respectively. Other known and suitable hash algorithms may be used as well.

The used hash function is also implemented in the SOC for execution by security module 130 for authenticating the data. So whenever SOC 110 reads the data from memory 120 it calculates a hash value of said data using the hash function stored in the SOC. The calculated hash value is then compared to the stored hash value. If the calculated hash value matches the stored hash value then the data read from memory 120 is authenticated, i.e. it is confirmed that the data read from memory 120 truly is original, unmodified data, or in other words digital identity is confirmed. Upon successful authentication the SOC may continue to process the data as intended, i.e. in this example the configuration data may be used for setting properties of the SOC. Accordingly the authenticated data may be stored in memory 150 for further processing by any other processing unit in the SOC. Memory 150 thus may be considered to be virtual one-time programmable memory, because the authentication procedure ensures that data written to memory 150 is unmodified.

The executable of the hash function used in the SOC may be stored securely such that it cannot be modified by a hacker trying to bypass the hash function. In one example the hash function may be stored in unmodifiable memory within the SOC. Alternatively the hash function can be hard coded into a logic or a state machine within the SOC, wherein the logic or state machine is implemented in the SOC as an application specific hardware block, such that it forms a fixed function hardware block executing the hash function rather than an unspecific CPU of the SOC.

In case that authentication of the data read from memory 120 fails, i.e. the calculated hash value does not equal the hash value stored in unmodifiable memory 140, then the security module will consider the data to be manipulated and will react accordingly. The SOC may at least stop further processing of the data in order to prevent any manipulation in the SOC. Depending on the particular implementation the system may for example write a logfile entry or may restrict its operation to a predefined level or may stop processing data at all.

In this way any amount of data can be stored outside the SOC and in memory being usually cheaper than one-time programmable memory while at the same time authenticity of the data is ensured before the data is further processed in the SOC. This embodiment thus provides a method for securing the authenticity of data in a digital processing system wherein a hash value is calculated for the data, the calculated hash value is stored in unmodifiable memory in the system and the data is authenticated by verifying the hash value each time the data is loaded from memory, i.e. a hash value is computed in the digital processing system based on the data read from memory and compared to the stored hash value. Depending on the outcome of the authentication the system may proceed with normal processing of the data or may restrict processing of the data and its operation in case the authentication failed.

In a second embodiment the same digital processing system, i.e. the same hardware, may be used, but a digital signature of the data is used instead of a hash value.

Digital signatures per se are known from public key infrastructures (PKI), wherein a pair of a public key and an associated private key are used. A digital signature of data can be computed by first computing a hash value of the data using a hash function as mentioned above. The hash value is then encrypted using an encryption function and using the private key of the key pair to compute an encrypted hash value, which represents the digital signature of the data.

The signature of the data and the public key of the key pair are then stored in unmodifiable memory 140 of the digital processing system, for example when manufacturing the system. The data itself may be stored in memory 120, which may be any conventional memory outside the SOC, for example non-volatile memory. Also the hash function for computing a hash value in the SOC and a decryption function for decrypting the encrypted hash value are provided to the digital processing system. It is apparent that the decryption function relates to the encryption function used for encrypting the hash value in order to decrypt the hash value using the public key stored in memory 140.

Authentication of the data in the digital processing system is similar to that described for the first embodiment. That is when the data stored in memory 120 is needed for processing in SOC 110, the security module 130 reads the data from memory 120. Then security module 130 calculates a hash value using the provided hash function based on the data read. Then security module 130 uses the provided decryption function and the provided public key to decrypt the digital signature, i.e. the encrypted hash value, to retrieve the stored hash value in clear. If the encrypted has value can be successfully decrypted, then this proves that the used public key is authentic, i.e. the key of the authority producing the digital signature. Then the decrypted hash value is compared to the computed hash value. In case the hash values match then the data read from memory 120 is authenticated, i.e. it is secured that the data is identical to the data used for computing the signature stored in unmodifiable memory 140 of the SOC.

Similar as described for the first embodiment the SOC may then continue processing depending on the outcome of the authentication, i.e. the SOC may either continue with normal processing of the data in case of a successful authentication or may restrict its operation due to an unsuccessful authentication.

The asymmetric encryption function may be any suitable function using a key pair comprising a private and a public key. In one example the RSA algorithm or an elliptic curve cryptography algorithm may be used as asymmetric encryption function.

In order to prevent any manipulation attempts of the SOC, in particular any attempts to tamper with executable code, the executable code for calculating the hash value and for decrypting the hash value may also be stored in unmodifiable memory such that these cannot be faked.

In both embodiments additional precautions can be taken to secure the operation of the SOC and in particular the security module 130. For example when booting the digital processing system the boot sequence for security system 130 may be provided from a secured storage, e.g. from one-time programmable memory, to ensure that the operation of security module is as intended by the vendor.

With respect to the above mentioned example of the data being configuration data for the SOC the data may be loaded automatically when powering up the digital processing system, i.e. in particular as part of the boot sequence.

Both described embodiments disclose a method for securing authenticity of data in a digital processing system wherein a check value, i.e. a hash value or a signature, is calculated outside the digital processing system using a corresponding authentication function, and wherein the calculated value is stored in unmodifiable memory in the system. For authenticating the data the stored check value is authenticated by using the authentication function in the digital processing system and based on the data to be authenticated. The authentication function may be a cryptographic hash function or an asymmetric encryption method, in which case the public key portion of the key pair used for calculating the signature is stored in the digital processing system.

Furthermore the hardware necessary for executing the described methods is disclosed, which essentially is a digital processing system adapted and configured for storing an authentication function and an authentication value in unmodifiable memory in the digital processing system, reading data from modifiable memory and then executing the authentication function based on the data and the stored authentication value, and processing the data depending on the result of the execution of the authentication function.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed.

What we claim is:

1. A method for securing authenticity of data in a digital processing system comprising:
calculating a hash value of the data using a hash function;
storing the calculated hash value in unmodifiable memory in the digital processing system;
calculating a hash value of the data in the digital processing system and comparing the calculated hash value to the stored hash value;
further processing of the data if the calculated hash value matches the stored hash value.

2. The method of claim 1, wherein the data is stored in modifiable memory in the digital processing system.

3. The method of claim 1, wherein the unmodifiable memory in the digital processing system is one-time programmable memory.

4. The method of claim 1, wherein the hash function is stored in unmodifiable memory in the digital processing system.

5. The method of claim 1, wherein the hash function is one of SHA1 or SHA-256 or MD5 or Whirlpool.

6. The method of claim 1, wherein the data is stored in modifiable memory in the digital processing system.

7. The method of claim 1, wherein the digital processing system restricts further processing of the data if the hash value calculated in the digital processing system differs from the hash value stored in the digital processing system.

8. The method of claim 1, comprising the further step of restricting the operation of the digital processing system if the hash value calculated in the digital processing system differs from the hash value stored in the digital processing system.

9. The method of claim 1, wherein the processed data controls the mode of operation of the digital processing system or allows or disallows functions of the digital processing system.

10. A method for securing authenticity of data in a digital processing system comprising:
calculating a digital signature of the data using an asymmetric cryptographic function and a pair of a public and a private key;
storing the digital signature of the data and the public key in unmodifiable memory in the digital processing system;
authenticating the digital signature of the data in the digital processing system by verifying the digital signature of the data using the asymmetric cryptographic function and the provided public key and the data;
providing the data to further processing if authentication of the digital signature is successful.

11. The method of claim 10, wherein the data is stored in modifiable memory in the digital processing system.

12. The method of claim 10, wherein the unmodifiable memory in the digital processing system is one-time programmable memory.

13. The method of claim 10, wherein the cryptographic function is stored in unmodifiable memory in the digital processing system.

14. The method of claim 10, wherein the asymmetric cryptographic function is one of RSA or an elliptic curve encryption function.

15. The method of claim 10, wherein the data is stored in modifiable memory in the digital processing system.

16. The method of claim 10, wherein the digital processing system restricts further processing of the data if the authentication of the digital signature of the data in the digital processing system fails.

17. The method of claim 10, comprising the further step of restricting the operation of the digital processing system if authentication of digital signature fails.

18. The method of claim 10, wherein the processed data controls the mode of operation of the digital processing system or allows or disallows functions of the digital processing system.

19. A method for securing authenticity of data in a digital processing system comprising:
calculating a check value of the data outside of the digital processing system using an authentication function;
storing the calculated check value in unmodifiable memory in the digital processing system;
authenticating the data in the digital processing system by authenticating the check value using the authentication function based on the data to be authenticated.

20. The method of claim 19, wherein the authentication function is an asymmetric cryptographic function, and further comprising the step of storing a public key in unmodifiable memory of the digital processing system prior to authenticating the check value.

21. The method of claim 19, wherein the authentication function is a hash function for calculating a hash value of the data.

22. A digital processing system adapted and configured for storing an authentication function in unmodifiable memory;
storing an authentication value in unmodifiable memory in the digital processing system;
reading data from modifiable memory;
executing the authentication function based on the data and the stored authentication value; and
further processing of the data depending on the result of the execution of the authentication function.

23. The digital processing system of claim 22, wherein the authentication function is a cryptographic hash function.

24. The digital processing system of claim 22, wherein the authentication function is an asymmetric cryptographic function and wherein the digital processing system is further adapted and configured for storing a public key in unmodifiable memory in the digital processing system.

25. The digital processing system of claim 22, wherein the unmodifiable memory is one-time programmable memory.

26. The digital processing system of claim 22, comprising a system on a chip comprising a security module for executing the authentication function and comprising the unmodifiable memory.

27. The digital processing system of claim 22, wherein the storing of the authentication function in unmodifiable memory is implemented in an application specific hardware block.
